(19) United States
(12) Patent Application Publication
(10) Pub. No.: US 2013/0235009 A1
(43) Pub. Date: Sep. 12, 2013

(54) ADJUSTING APPARATUS AND METHOD FOR ADJUSTING BRIGHTNESS OF DISPLAYS

(71) Applicants: I-CHAN HU, Tu-Cheng (TW); CHI-LEI HO, Tu-Cheng (TW); CHENG-TA HU, Tu-Cheng (TW)

(72) Inventors: I-CHAN HU, Tu-Cheng (TW); CHI-LEI HO, Tu-Cheng (TW); CHENG-TA HU, Tu-Cheng (TW)

(21) Appl. No.: 13/662,873

(22) Filed: Oct. 29, 2012

(30) Foreign Application Priority Data
Mar. 12, 2012 (TW) 101108339

(51) Int. Cl. G09G 5/10

(52) U.S. Cl. 345/207

(57) ABSTRACT

An adjusting apparatus includes a display, a host, and a luminance sensing device. The host includes a control module, a comparing module, and a storing module. The control module controls the display to display according to a first initial luminance value. The luminance sensing device senses brightness of the display and sends a first current luminance value, corresponding to the brightness, to the comparing module. The comparing module stores the first initial luminance value to the storing module after determining the first current luminance value to match with a first reference luminance value. The control module decreases the first initial luminance value to a second initial luminance value and controls the display to display according to the second initial luminance value.

### BACKGROUND

1. Technical Field

The disclosure generally relates to an adjusting apparatus and method for adjusting the brightness of a display.

2. Description of Related Art

A typical display of a notebook computer includes a fixed range of luminance levels, such as 11 levels. The luminance range has 256 values which are uniformly spaced from 0 to 255. Each luminance level corresponds to a luminance value, such as the first level corresponding to 0, the second level corresponding to 20, for example. However, the luminance levels are adjusted manually by operating a device and the luminance levels of different types of displays correspond to different values. It is inefficient to adjust the luminance levels to meet required standard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of an adjusting apparatus according to one embodiment of the present disclosure.

FIG. 2 is another schematic diagram of an adjusting apparatus according to one embodiment of the present disclosure.

FIG. 3 is a flow diagram of an adjusting method according to one embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

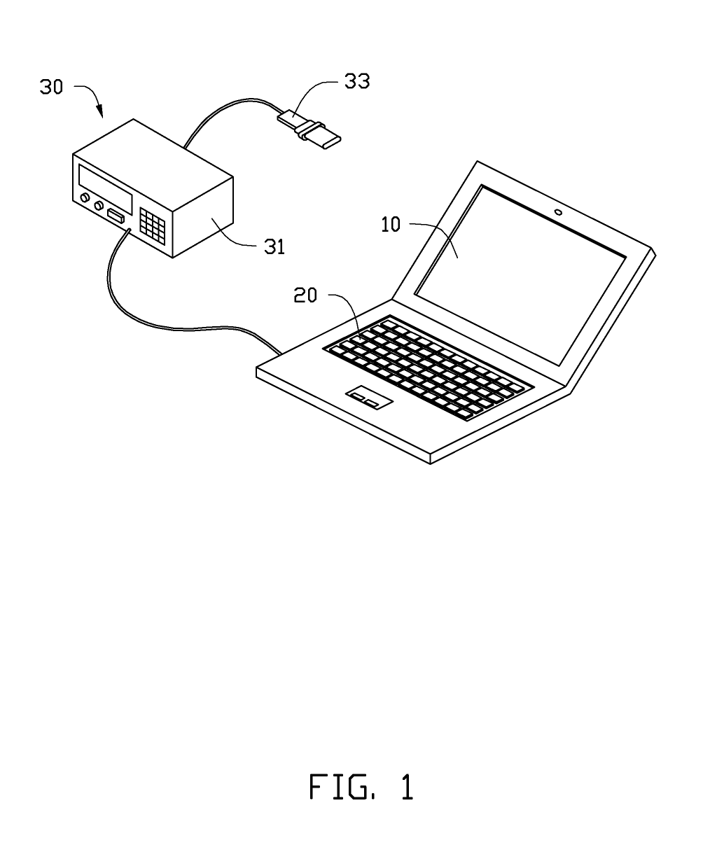

FIG. 1 is a schematic diagram of an adjusting apparatus according to one embodiment. The adjusting apparatus includes a display 10, a host 20, and a luminance sensing device. In one embodiment, the display 10 and the host 20 are included in a notebook, and the luminance sensing device is a CA201 color analyzer 30. The color analyzer 30 includes an analyzer body 31 and a sensor 33 connected to the analyzer body 31. The sensor 33 is used for sensing the brightness of the backlight board. The analyzer body 31 is connected to the host 20 via a cable. In one embodiment, the cable is a USB cable.

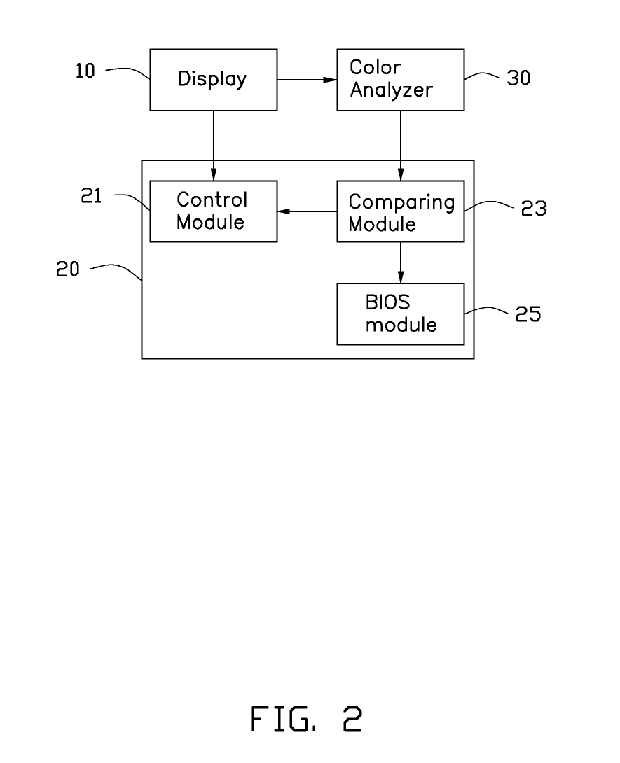

Referring to FIG. 2, the host 20 includes a control module 21 connected to the display 10, a comparing module 23 connected to the color analyzer 30, and BIOS module 25. The control module 21 is configured to control the display to display according to an initial luminance value. The color analyzer 30 is configured to sense the current brightness of the display 10, convert the current brightness to a current luminance value, and send the current luminance value to the comparing module 23 of the host 20. The comparing module 23 is configured to compare the current luminance value with a reference luminance value. If the current luminance value matches with the reference values, the comparing module 23 stores the initial luminance value and the display information of the display to the BIOS module 25. If the current luminance value does not match with the reference values, the control module 21 decreases the initial luminance value and control the display 10 to display according to the decreased initial luminance value. In one embodiment, the BIOS module 25 includes a storing module for storing the initial luminance value and the display information. In one embodiment, the storing module is EPROM module.

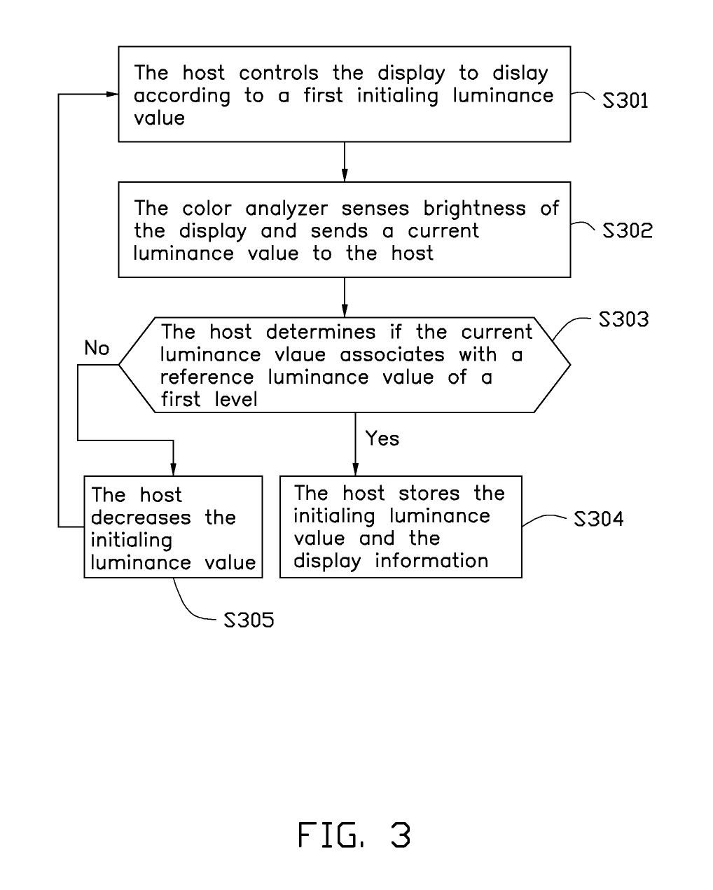

Referring to FIG. 3, an embodiment of an adjusting method for adjusting brightness is shown as below.

S301, the control module 21, of the host 20, causes the display 10 to display according to an initial luminance value. In one embodiment, the initial luminance value is 255.

S302, the sensor 33 of the color analyzer 30 senses the current brightness of the display 10, and sends a current luminance value, corresponding to the current brightness, to the comparing module 23 of the host 20.

S303, the comparing module 23 compares the current luminance value with a reference luminance value of the first level. The comparing module 23 determined if the current luminance value matches with the reference luminance value.

S304, the comparing module 23 stores the initial luminance value and the display information of the display 10 to the BIOS module 25. The display information includes the type of the display.

S305, the control module 21 decreases the initial luminance by 1, and the flow turns to S301.

In the above method, the control module 21 decreases the initial luminance value by 1 to a second initial luminance value, after the step S304, and controls the display 10 to display according to the second initial luminance value. The sensor 33 of the color analyzer 30 senses the second current brightness of the display 10 and sends a second current luminance value to the comparing module 23. The comparing module 23 compares the second current luminance value with a second reference luminance value of the second level. The comparing module 23 stores the different initial luminance values in the BIOS module 25 in this way.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. An adjusting apparatus comprising:
a display;
a host, the host comprises a control module, a comparing module, and a storing module; the control module is configured to control the display to display according to a first initial luminance value; and
a luminance sensing device, the luminance sensing device is configured to sense brightness of the display and send a first current luminance value, corresponding to the brightness, to the comparing module;
wherein the comparing module is configured to store the first initial luminance value to the storing module, after determining if the first current luminance value to match with a first reference luminance value; and the control module is further configured to decrease the first initial luminance value to a second initial luminance value and to control the display to display according to the second initial luminance value.

2. The adjusting apparatus of claim 1, wherein the control module is further configured to decrease the first initial luminance value to the second initial luminance value after the comparing module stores the first initial luminance value to the storing module, and to control the display to display according to the second initial luminance value; the comparing module is configured to determine if a second current luminance value, sent by the luminance sensing device, matches with a second reference luminance value, after the display displays according to the second initial luminance value.

3. The adjusting apparatus of claim 1, wherein the comparing module is further configured to store display information to the storing module after determining that the first current luminance value matches with the first reference luminance value.

4. The adjusting apparatus of claim 3, wherein the display information comprises a type of the display.

5. The adjusting apparatus of claim 1, wherein the storing module is located in a BIOS module of the host.

6. An adjusting method for brightness, the adjusting method comprising:
controlling a display to display according a first initial luminance value;
receiving a first current luminance value from a luminance sensing device after the luminance sensing device senses brightness of the display;
storing the first initial luminance value after determining the first current luminance value matches with a first reference luminance value; and
decreasing the first initial luminance value to a second initial luminance value after determining that the first current luminance value does not match with the first reference luminance value, and controlling the display to display according to the second initial luminance value;
wherein the above steps are performed by a host.

7. The adjusting method of claim 6, further comprising decreasing the first initial luminance value to the second initial luminance value, after storing the first initial luminance value; controlling the display to display according to the second initial luminance value; and determining if a second current luminance value, sent by the luminance sensing device, matches with a second reference luminance value after the display displays according to the second initial luminance value.

8. The adjusting method of claim 6, further storing display information after determining that the first current luminance value matches with the first reference luminance value.

9. The adjusting method of claim 8, wherein the display information comprises a type of the display.

10. An adjusting method for brightness, the adjusting method comprising:
providing an adjusting apparatus, the adjusting apparatus comprising a display, a host, and a luminance sensing device;
controlling the display to display according a first initial luminance value by the host;
receiving a first current luminance value from the luminance sensing device after the luminance sensing device senses brightness of the display by the host;
storing the first initial luminance value after determining the first current luminance value matches with a first reference luminance value by the host; and
decreasing the first initial luminance value to a second initial luminance value by the host after determining that the first current luminance value does not match with the first reference luminance value, and controlling the display to display according to the second initial luminance value.
